(19) United States
(12) Patent Application Publication
(10) Pub. No.: US 2015/0112817 A1
(43) Pub. Date: Apr. 23, 2015

(54) SYSTEMS AND METHODS FOR SHARING DATA TO ENHANCE A CONSUMER EXPERIENCE

(71) Applicant: SAM PETER HAMILTON, Los Altos, CA (US)

(72) Inventor: SAM PETER HAMILTON, Los Altos, CA (US)

(21) Appl. No.: 14/059,324

(22) Filed: Oct. 21, 2013

(51) Int. Cl. G06Q 30/06; G06Q 30/02

(52) U.S. Cl. CPC G06Q 30/0631; G06Q 30/0277
USPC 705/14.73; 705/26.7

(57) ABSTRACT

Systems and methods for enhancing a consumer experience using shared data is provided. The system includes a shared data server in communication with one or more merchant sites and a remote server that may include a payment processing server. The shared data server receives, stores, and analyzes information provided from the merchant sites and the remote server to provide recommendations, offers, and the like to the consumer to enhance their experience. The shared data server may also provide upselling opportunities for the merchant site based on its analysis as well as opportunities to extend credit to consumers for the remote server based on its analysis of the received information. The shared data server may allow merchant sites and remote servers to make indirect use of the information that each has individually about products and customers without providing direct access to the information.

### BACKGROUND

1. Technical Field

Embodiments as described herein may be related to systems and methods for sharing data to enhance a consumer experience.

2. Related Art

The increased use of the internet and internet capable devices has led to the increased use of online payment processors due to the convenience that these processors provide. Online payment processors may provide consumers with the ability to purchase items with minimal effort from their internet capable device, with the payments being handled through a consumer's credit or checking account, or through a financial account that the consumer has set up with the payment processor. Online payment processors have been well integrated with merchants online, and are beginning to become more integrated with merchants' offline presence as well such that the consumer can walk into a store and pay for an item using the online payment processor. When a consumer does this, the merchant receives some information about the consumer, and the payment processor also receives some information about the consumer. However, the information received by the payment processor may not be the same as the information received by the merchant. Moreover, the merchant may know nothing about the consumer's interest, preference, or purchase history, and the payment processor may not know the item level details of the purchase and know nothing about the purchases that the consumer makes with the merchant that are not processed by the payment processor. The consumer, on the other hand, is looking for convenience and an enhanced experience, whether shopping online or at a physical store and may reward merchants that provide convenience and an enhanced experience with repeat business.

### BRIEF DESCRIPTION OF THE FIGURES

FIG. 1 is a diagram of a networked system, consistent with some embodiments.

FIG. 2 is a diagram illustrating computing system, consistent with some embodiments.

FIG. 3 is a diagram illustrating a flow of using shared data to enhance a consumer experience, consistent with some embodiments.

FIG. 4 is a flowchart illustrating a process for enhancing a consumer experience using shared data, consistent with some embodiments.

FIG. 5 is a flowchart illustrating a process for offering a consumer credit using shared data, consistent with some embodiments.

In the drawings, elements having the same designation have the same or similar functions.

### DETAILED DESCRIPTION

In the following description specific details are set forth describing certain embodiments. It will be apparent, however, to one skilled in the art that the disclosed embodiments may be practiced without some or all of these specific details. The specific embodiments presented are meant to be illustrative, but not limiting. One skilled in the art may realize other material that, although not specifically described herein, is within the scope and spirit of this disclosure.

What is needed are systems and methods for sharing the data collected and processed by a payment processor with the data collected and stored by a merchant to use the shared data to enhance the consumer experience.

Consistent with some embodiments, there is provided a shared data system. The shared data system includes a network interface component configured to receive consumer information and consumer financial information from a remote server, receive product information from a merchant server associated with a merchant, and receive merchant-specific information related to a consumer from the merchant server. The system also includes one or more processors configured to analyze the received consumer information, consumer financial information, product information and merchant-specific consumer information, and generate a consumer-related recommendation based on the analysis. The system further includes a memory configured to store the received consumer information and consumer financial information and the product information and merchant-specific consumer information such that the merchant server cannot access information received from the remote server and the remote server cannot access the information received from the merchant server.

Consistent with some embodiments, there is also provided a method for enhancing an experience of a consumer using shared data. The method includes steps of receiving consumer information and consumer financial information from a remote server, receiving product information from a merchant server associated with a merchant, and receiving merchant-specific information related to a consumer from the merchant server, storing the received consumer information and consumer financial information and the product information and merchant-specific consumer information such that the merchant server cannot access information received from the remote server and the remote server cannot access the information received from the merchant server, analyzing the received consumer information, consumer financial information, product information and merchant-specific consumer information, and generating, by the one or more processors of the shared data server, a consumer-related recommendation based on the analysis. The method may be embodied in computer-readable media.

Consistent with some embodiments, there is further provided a method. The method includes steps of receiving a request to process a payment from a consumer to a merchant, reviewing information from a credit database, reviewing information received from a shared data server in communication with the payment processing server, determining if the consumer requesting the payment to be processed should be extended an offer for credit based on the received information, providing a credit offer for an amount greater than an amount of the payment that the consumer requested to be processed when the determining determines that the consumer should be extended an offer for credit, and processing the requested payment when the determining determines that the consumer should not be extended an offer for credit. The method may be embodied in computer-readable media.

Embodiments consistent with this disclosure may allow a merchant to be provided with recommendations for upselling and accessorizing a consumer's purchase, while also providing a payment processor with the ability to collect interest and additional fees. At the same time, embodiments consistent with this disclosure may allow a merchant and payment processor to enhance a consumer's experience by providing relevant recommendations, targeted advertisements and specials, and opportunities to secure credit for purchasing improved quality items and accessories.

These and other embodiments will be described in further detail below with respect to the following figures.

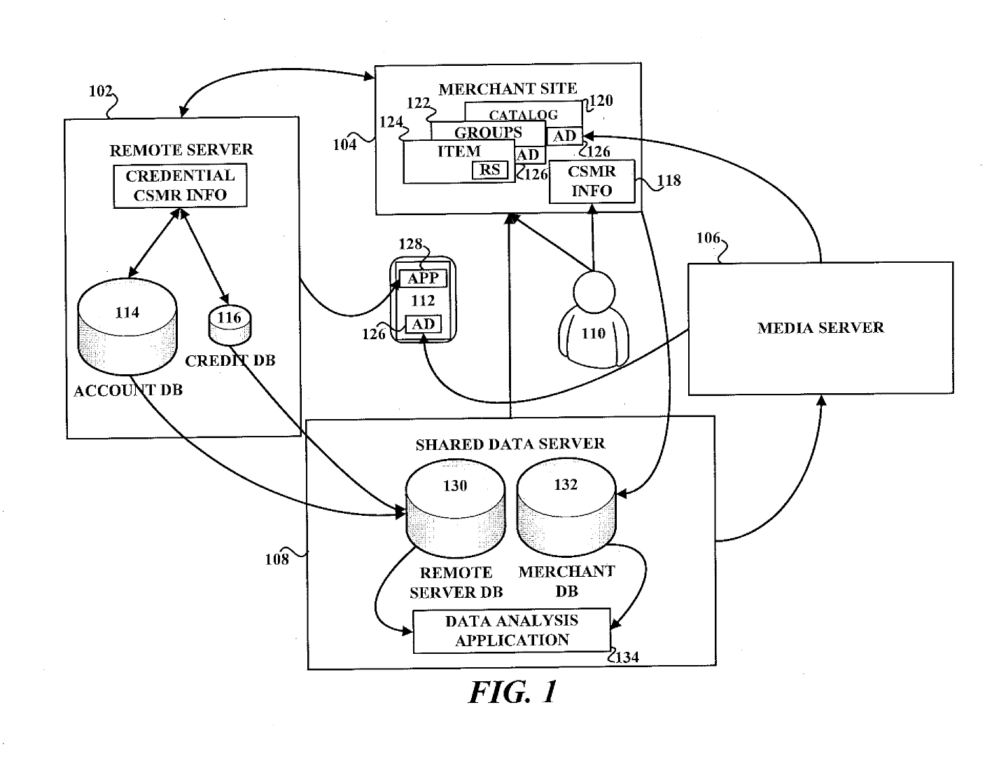

FIG. 1 is a diagram of a networked system 100, consistent with some embodiments. As shown in FIG. 1, system 100 includes a remote server 102, a merchant site 104, a media server 106, a shared data server 108, a consumer 110, and a consumer computing device 112. As also shown in FIG. 1, remote server 102, merchant site 104, media server 106, shared data server 108 and consumer computing device 112 may be in communication with one or more of the other components of system 100. In some embodiments, the components of system may be in communication with each other over a network. The network that connects the components of system 100 may be implemented as a single network or a combination of multiple networks, and may include the Internet and/or one or more intranets, landline networks, wireless networks, and/or other appropriate types of communication networks. In another example, the network may comprise a wireless telecommunications network (e.g., cellular phone network) adapted to communicate with other communication networks, such as the Internet.

Remote server 102 may be a payment service provider server that may be maintained by a payment provider, such as PayPal, Inc. of San Jose, Calif. Remote server 102 may be maintained by other service providers in different embodiments. Remote server 102 may also be maintained by an entity with which sensitive credentials and information may be exchanged with merchant site 104, consumer computing device 112. Remote server 102 may be more generally a web site, an online content manager, a service provider, such as a bank, or other entity who provides content to a user requiring user authentication or login.

Remote server 102, according to some embodiments, may be maintained by an online payment provider, which may provide processing for online financial and payment transactions on behalf of merchant site 104 and consumer 110 for the processing of payments for the purchase of goods and services (collectively referred to as “items”) from a merchant by consumer 110. In some embodiments, remote server 102 may receive or charge fees for processing payments. Remote server 102 may also be capable of providing and extending credit to consumer for interest and/or fees. Remote server 102 may include an account database 114 that includes account information for users having an account on remote server 102, such as consumer 110. Remote server 102 may also include or be in communication with a credit database 116 that includes information related to a creditworthiness of a user such as consumer 110. Such creditworthiness information may include information about past purchases made by consumer 110 (which may also be stored in account database 114), and a credit score of consumer 110 which may be determined based on information within account database 114 and/or credit database 116 or may be retrieved from a third party credit reporting agency. Such information may also include an amount of credit to which consumer 110 may qualify at a particular time. In some embodiments, remote server 102 may include functionalities and applications for providing credit to consumer 110 with interest. Remote server 102 may also include functionalities, applications, and/or executable programs for authentication, which may be used to authenticate consumer computing device 112 or merchant site 104 based, in part, on information in account database 114.

Merchant site 104 may collectively refer to any of a website for a particular merchant (i.e., digital storefront), a merchant's physical storefront, and/or a merchant computing device that is in communication with any of the components of system 100 shown in FIG. 1. As shown in FIG. 1, merchant site 104 is depicted as a digital storefront having content accessible by a consumer, such as consumer 110, over a network. In some embodiments, the merchant site 104 may include one or more merchant servers (not shown) and include one or more databases, that may include such information as consumer information and consumer purchase history (collectively illustrated as user info 118 in FIG. 1), product information, and a catalog 120 of available products. The digital storefront may include one or more digital content features, which may be webpages, that may provide consumer 110 viewing the digital storefront with information such as a catalog 120 of items, which may be refined by particular groups 122 of items, and further refined as particular items 124. Merchant site 104 may allow consumer 110 to purchase item 124 by paying via a payment processor such as may be provided by remote server 102 by providing a link to remote server 104 on the item webpage 124 (labeled “RS” in FIG. 1), a checkout or shopping cart webpage, or on a point-of-sale system within a physical storefront.

Merchant site 104 may also be a physical storefront in which consumer 110 can enter, browse available items, and purchase desired items. Merchant site 104 may also include a merchant computing device having one or more processors that may be configured to execute instructions stored in a memory of the merchant computing device for facilitating the purchase of items by consumer 110. In some embodiments, merchant site 104 may include a point-of-sale device that is in communication with remote server 102 over a network such that consumer 110 may pay for items purchased in the physical storefront using payment processing capabilities of remote server 102. For example, as shown in FIG. 1, consumer 110 may use a merchant computing device, such as a point-of-sale device, to submit a credential 126 to remote server 102 for authentication with remote server 102, wherein the authentication may be used to authorize a payment to be made to merchant site 104 based on information stored in account database 114. Upon successful authentication and authorization, remote server 102 may be capable of transferring funds for the purchase of the items from an account associated with consumer 110 to an account associated with merchant site 104.

Media server 106 may be one or a collection of servers that may be in communication with one or more components of system 100 for providing media to the components of system 100. The media may include targeted advertisements, video advertisements, offers, specials, discounts, and the like. In some embodiments, the media provided by media server 106 may be provided to components of system 100 based on information about merchant site 104 or consumer 110 received from shared data server 108. For example, as shown in FIG. 1, media server 106 may be capable of providing one or more advertisements or ads 128 to consumer computing device 112 or within catalog 120 and group 122 webpages included in merchant site 104. In some embodiments, the ads may be triggered by information about consumer 110 and/or merchant site 104. Moreover, ads 126 provided by media server 106 may be provided based on a geofence or geolocation such that when consumer 110 and consumer computing device 112 are determined to be near a physical storefront associated with merchant site 104, ads 126 may be provided to consumer computing device 112 for viewing by consumer 110.

Consumer computing device 112 may be implemented using any appropriate combination of hardware and/or software configured for wired and/or wireless communication over a network to communicate with components of system 100. For example, consumer computing device 112 may be implemented as a wireless telephone e.g., smart phone), tablet, personal digital assistant (PDA), notebook computer, personal computer, a connected set-top box (STB) such as provided by cable or satellite content providers, or a video game system console, a head-mounted display (HMD) or other wearable computing device, including a wearable computing device having an eyeglass projection screen, and/or various other generally known types of computing devices.

Consumer computing device 112 may include any appropriate combination of hardware and/or software having one or more processors and capable of reading instructions stored on a tangible non-transitory machine-readable medium for execution by the one or more processors. Consistent with some embodiments, consumer computing device 112 includes a machine-readable medium, such as a memory (not shown) that includes instructions for execution by one or more processors (not shown) for causing consumer computing device 112 to perform specific tasks. In some embodiments, the instructions may be executed by the one or more processors in response to interaction by consumer 110. For example, such instructions may include a browser application such as a mobile browser application, which may be used to provide a user interface to permit consumer 110 to browse information available over the network, including information hosted by remote server 102 and merchant site 104.

Consumer computing device 112 may also include an application 128 associated with remote server 102 that allows consumer 110 using consumer computing device 102 to send and receive information to and from remote server 102. Application 128 may also allow consumer 110 to enter into and perform transactions, including authorizing payments to merchant site 104 to be processed by a payment service processing provider, such as may be provided by PayPal, Inc. of San Jose, Calif. and implemented by remote server 102. Application 128 may include additional functionalities, such as allowing consumer 110 to check in to merchant site 104 when consumer 110 is visiting the physical storefront included in merchant site 104. Application 128 may also allow consumer computing device 112 to receive specials, offers, alerts, and other information related to remote server 102 and/or merchant site 104 based on a determined location of consumer computing device 112 and consumer 110.

Consumer computing device 112 may include other applications as may be desired in one or more embodiments to provide additional features available to consumer 110, including interfaces and communication protocols that allow the user to receive and transmit information through the network and to remote server 102, merchant site 104, and other online sites. The other applications may also include security applications for implementing client-side security features, programmatic client applications for interfacing with appropriate APIs over the network or various other types of generally known programs and/or applications. These other applications, as well as application 128, may include mobile applications downloaded and resident on consumer computing device 112 that enables consumer 110 to access content through the applications.

Shared data server 108 may be one or more servers and one or more databases capable of receiving data from remote server 102 and merchant site 104, and analyzing the data to provide additional information related to the analyzed data to remote server 102 and merchant site 104. In some embodiments, shared data server 108 may include a remote server database 130 that may receive and store data and information from remote server 102. Such data and information from remote server 102 may include information from account database 114 that may include information about a user, such as consumer 110, including past purchases, purchase amounts, purchase locations, items purchased and the likes. The data and information from remote server 102 may further include information from credit database 116 such as financial information related to how creditworthy a user is and how much credit a particular user could be extended. The data and information received from remote server 102 may be stored in remote server database 130.

Shared data server 108 may also include a merchant database 132 that may receive and store information from merchant site 104. The information received from merchant site 104 may include information related to a user such as consumer 110 that includes a user's purchase history, including the items purchased, purchase amounts, and the like. The information received from merchant site 104 may also include catalogs, product information, product descriptions, specials, sales, offers, and the like. The information received by shared data server 108 from merchant site 104 may include information from a merchant's digital and physical storefronts. The data and information received from merchant site 104 may be stored in merchant database 132.

Shared data server 108 may also include a data analysis application 134 capable of analyzing information and data from remote server database 130 and merchant database 132 to provide additional information related to the analyzed data to remote server 102 and merchant site 104. In some embodiments, data analysis application 134 may include one or more data analysis algorithms configured to provide relevant information related to the information stored in remote server database 130 and merchant database 132 to remote server 102 and merchant site 104. In some embodiments, the relevant information may include information that is available to one of remote server 102 and merchant site 104, but not available to the other. Moreover, the relevant information provided by shared data server 108 may be provided to consumer 110 and/or consumer computing device 112 as well as media server 106 and other third party websites.

In some embodiments, the relevant information provided by shared data server 108 may be provided to enhance the experience of consumer 110. For example, based on information provided by shared data server 108 to merchant site 104, consumer 110 may be offered credit, related items for purchase, and specials based on information related to credit and past purchases stored in remote server database 130 which would normally not be known by or provided to merchant site 104. Moreover, the relevant information provided by shared data server 108 may be provided to consumer 110 through application 128 by remote server 102 when consumer 110 is determined to be near a physical storefront of merchant site 104. The relevant information may also be provided to third party websites such that when consumer 110 is visiting the website, the relevant information may be provided to consumer 110 in the forms of ads or redirections to merchant site 104.

In one example, data analysis application 134 may provide information to media server 106 which may provide ads for specials at merchant site 104 to a third party website when consumer 110 visits the third party website. Consumer 110 may view ad 126 while visiting the third party website using consumer computing device 112 and then may visit a physical storefront of merchant site 104 to take advantage of ad 126. When consumer 110 is purchasing an item at the physical storefront of merchant site 104 based on ad 126, a point-of-sale device or other computing device within the physical storefront may receive information from data analysis application 134 of shared data server 108, such as an offer for credit to purchase an upgrade to the item the consumer 110 is purchasing and/or accessories for the item relevant to consumer 110 based on a known purchase history of consumer 110. If consumer 110 has recently purchased items for children either from merchant site 104 or through remote server 104, this information will be determined by data analysis application 134 and recommendations for children-related accessories or options to the item that consumer is purchasing may be offered. As a result, data analysis application 134 of remote server 108 may enhance the experience of consumer 110, while providing merchant site 104 with opportunities for upselling and merchandising or accessorizing to increase their profit potential with consumer 110.

In some embodiments, merchant site 104 may be required to opt-in to the sharing of information with shared data server 108. Similarly, consumer 110 may be required to opt in to have their information shared and used to provide them with options when purchasing. Moreover, the information provided by remote server 102 to remote server database 130 of shared data server 104 is not directly accessible by merchant site 104. Similarly, the information provided by merchant site 104 to merchant database 132 of shared data server may not be directly accessible by remote server 102.

Although discussion has been made of applications on consumer computing device 112, remote server 102, and shared data server 108, the applications may also be, in some embodiments, modules. Module, as used herein, may refer to a software module that performs a function when executed by one or more processors or Application Specific Integrated Circuit (ASIC) or other circuit having memory and at least one processor for executing instructions to perform a function, such as the functions described as being performed by the applications.

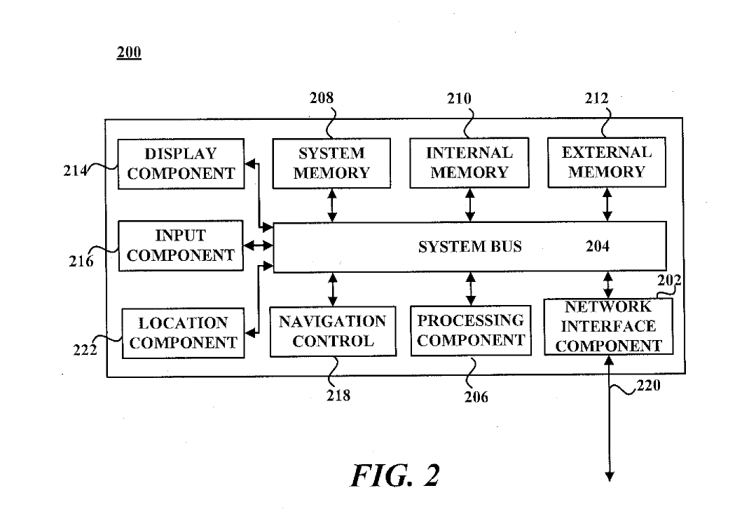

FIG. 2 is a diagram illustrating computing system 200, which may correspond to any of remote server 102, a computing device associated with merchant site 104, media server 106, shared data server 108, or consumer computing device 112. Computing system 200 may be a mobile device such as a smartphone, a tablet computer, a personal computer, laptop computer, netbook, or tablet computer, set-top box, video game console, head-mounted display (HMD) or other wearable computing device as would be consistent with consumer computing device 112 or a computing device such as may be associated with merchant site 104 such as a point-of-sale device. Further, computing system 200 may also be a server or one server amongst a plurality of servers, as would be consistent with remote server 102, a server hosting or otherwise associated with merchant site 104, media server 106, and shared data server 108. As shown in FIG. 2, computing system 200 includes a network interface component (NIC) 202 configured for communication with a network. Consistent with some embodiments, NIC 202 includes a wireless communication component, such as a wireless broadband component, a wireless satellite component, or various other types of wireless communication components including radio frequency (RF), microwave frequency (MWF), and/or infrared (IR) components configured for communication with a network. Consistent with other embodiments, NIC 202 may be configured to interface with a coaxial cable, a fiber optic cable, a digital subscriber line (DSL) modem, a public switched telephone network (PSTN) modem, an Ethernet device, and/or various other types of wired and/or wireless network communication devices adapted for communication with a network.

Consistent with some embodiments, computing system 200 includes a system bus 204 for interconnecting various components within computing system 200 and communication information between the various components. Such components include a processing component 206, which may be one or more processors, micro-controllers, graphics processing units (GPUs) or digital signal processors (DSPs), a system memory component 208, which may correspond to random access memory (RAM), an internal memory component 210, which may correspond to read-only memory (ROM), and an external or static memory 212, which may correspond to optical, magnetic, or solid-state memories. Consistent with some embodiments, computing system 200 further includes a display component 214 for displaying information to a user of computing system 200. Display component 214 may be a liquid crystal display (LCD) screen, an organic light emitting diode (OLED) screen (including active matrix AMOLED screens), an LED screen, a plasma display, or a cathode ray tube (CRT) display. Computing system 200 may also include an input component 216, allowing for a user of computing system 200 to input information to computing system 200. Such information could include payment information such as an amount required to complete a transaction, account information, authentication information such as a credential, or identification information. An input component 216 may include, for example, a keyboard or key pad, whether physical or virtual. Computing system 200 may further include a navigation control component 218, configured to allow a user to navigate along display component 214. Consistent with some embodiments, navigation control component 218 may be a mouse, a trackball, or other such device. Moreover, if device 200 includes a touch screen, display component 214, input component 216, and navigation control 218 may be a single integrated component, such as a capacitive sensor-based touch screen.

Computing system 200 may perform specific operations by processing component 206 executing one or more sequences of instructions contained in system memory component 208, internal memory component 210, and/or external or static memory 212. In other embodiments, hard-wired circuitry may be used in place of or in combination with software instructions to implement the present disclosure. Logic may be encoded in a computer readable medium, which may refer to any medium that participates in providing instructions to processing component 206 for execution. Such a medium may take many forms, including but not limited to, non-volatile media, volatile media, and transmission media. The medium may correspond to any of system memory 208, internal memory 210 and/or external or static memory 212. Consistent with some embodiments, the computer readable medium is tangible and non-transitory. In various implementations, non-volatile media include optical or magnetic disks, volatile media includes dynamic memory, and transmission media includes coaxial cables, copper wire, and fiber optics, including wires that comprise system bus 204. According to some embodiments, transmission media may take the form of acoustic or light waves, such as those generated during radio wave and infrared data communications. Some common forms of computer readable media include, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, carrier wave, or any other medium from which a computer is adapted to read.

In various embodiments of the present disclosure, execution of instruction sequences to practice the present disclosure may be performed by computing system 200. In various other embodiments of the present disclosure, a plurality of computing systems 200 coupled by a communication link 220 to a network (e.g., such as a LAN, WLAN, PTSN, and/or various other wired or wireless networks, including telecommunications, mobile, and cellular phone networks) may perform instruction sequences to practice the present disclosure in coordination with one another. Computing system 200 may transmit and receive messages, data and one or more data packets, information and instructions, including one or more programs (i.e., application code) through communication link 220 and network interface component 202. Communication link 220 may be wireless through a wireless data protocol such as Wi-Fi™, 3G, 4G, HDSPA, LTE, RF, NFC, or through a wired connection. Network interface component 202 may include an antenna, either separate or integrated, to enable transmission and reception via communication link 220. Received program code may be executed by processing component 206 as received and/or stored in memory 208, 210, or 212.

Computing system 200 may further include a location component 222 for determining a location of computing system 200. In some embodiments, location component 222 may correspond to a GPS transceiver that is in communication with one or more GPS satellites. In other embodiments, location component 222 may be configured to determine a location of computing system 200 by using an IP address lookup, or by triangulating a position based on nearby telecommunications towers or WAPs. Location component 222 may also be capable of determining a proximity of computing device 200, for example by using radio frequency identification (RFID), Bluetooth™, and other such wireless technologies such that when computing device 200 is capable of receiving a wireless signal, information may be communicated in order to ascertain that computing device 200 is in the proximity of a transmitter or beacon. Location component 222 may be further configured to store a user-defined location in any of system memory 208, internal memory 210, and/or external memory 212 that can be transmitted to a third party for the purpose of identifying a location of computing system 200.

Computing system 200 may include more or less components than shown in FIG. 2 according to some embodiments. Moreover, components shown in FIG. 2 may be directly coupled to one or more other components in FIG. 2, eliminating a need for system bus 204. Furthermore, components shown in FIG. 2 may be shown as being part of a unitary system 200, but may also be part of a system where the components are separate but coupled and in communication. In general, the components shown in FIG. 2 are shown as examples of components in a computing system 200 capable of performing embodiments disclosed herein. However, a processing system 200 may have more or fewer components and still be capable of performing some embodiments disclosed herein.

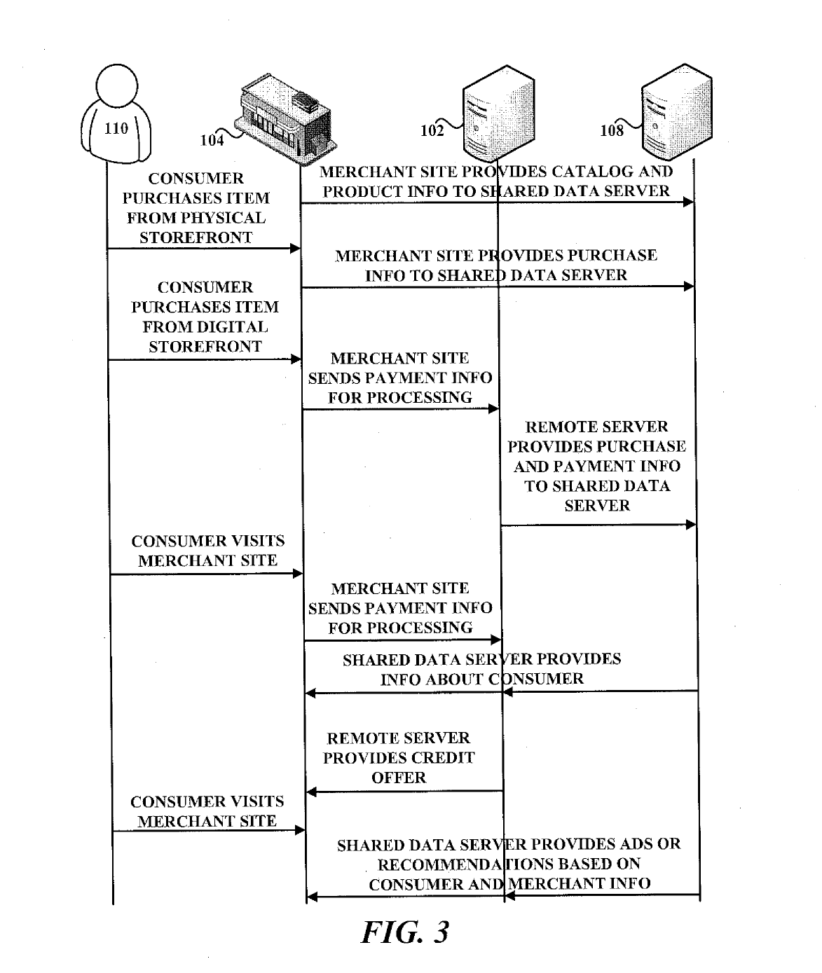

FIG. 3 is a diagram illustrating a flow of using shared data to enhance a consumer experience, consistent with some embodiments. Reference may be made to FIG. 1 and FIG. 2 during the discussion of FIG. 3. As shown in FIG. 3, if a merchant maintaining digital and/or physical storefronts of merchant site opts in to sharing data, merchant site 104 may provide their catalog and product information to shared data server 108. Merchant site 104 may further provide updates and specials or offers periodically. If consumer 110 has also opted in to sharing data, when consumer 110 purchases an item at a physical storefront of merchant site 104, merchant site 104 may provide consumer information 118 including information about the current purchase to shared data server 108. Similarly, when consumer 110 purchases an item from the digital storefront of merchant site 104, merchant site may also provide information related to the purchase to shared data server 108. Moreover, when consumer uses remote server 102 to process a payment to merchant site 104 for completing the purchase, merchant site 104 may send payment information to remote server 102 for payment processing, and remote server 102 may provide purchase and payment information to shared data server 108.

Once shared data server 108 has sufficient information about consumer 110 and merchant site 104, data analysis application 134 may be able to analyze information stored in remote server database 130 and merchant database 132 to enhance the experience of consumer 110. Consequently, when consumer 110 visits merchant site 104 (either physical storefront or digital storefront) and purchases an item using remote server 102 to process the payment for the purchase, merchants site 104 may send the payment information to remote server 102 for processing. Shared data server 108 may provide information about and related to consumer 110 and the purchase to both remote server 102 and merchant site 104. In one example, based on the provided information, remote server 102 may provide an offer of credit to merchant site 104 which may then be extended to consumer 110. For example, if consumer 110 is purchasing a low to mid-range bicycle, remote server 102 may be provided with information from shared data server 108 that consumer qualifies for credit well in excess of the purchase price of the low to mid-range bicycle. This information may also be provided to merchant site 104 in the form of a recommendation of a top of the line, or close thereto, bicycle. Consequently, merchant site 104 may offer the top of the line bicycle to consumer 110 along with credit to purchase the bicycle provided by remote server 102. As a result, consumer 110 is provided with the means to purchase a better item, remote server 102 is able to provide credit and receive interest, and merchant site 104 is able to upsell.

In another example, when consumer visits merchant site 104, shared data server 108 may provide merchant site 104 and/or remote server 106 and/or media server 106 (not shown in FIG. 3) with advertisements, recommendations, and other relevant information based on consumer and merchant information stored in shared data server 108. For example, if consumer 110 is purchasing (physical or digital storefront) or browsing (digital storefront) a bicycle, data analysis application 134 may determine that consumer 110 has not previously purchased a helmet, and recommend a helmet from catalog 120 of merchant site 104, or provide an advertisement 126 or special offer for a helmet. Moreover, data analysis application 134 may determine that consumer 110 has recently purchased children's clothing and provide recommendations for a child trailer attachment for the bicycle. As a result, consumer 110 is provided with item recommendations that may be useful and merchant site 104 is provided with the ability to sell additional items.

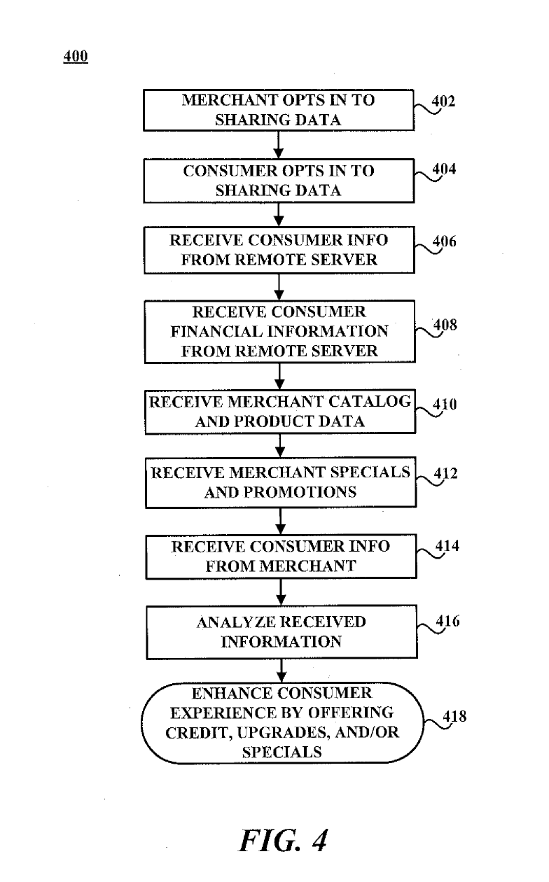

FIG. 4 is a flowchart illustrating a process 400 for enhancing a consumer experience using shared data, consistent with some embodiments. For the purpose of illustration, FIG. 4 may be described with reference to any of FIGS. 1-3. Process 400 shown in FIG. 4 may be embodied in computer-readable instructions for execution by one or more processors such that the steps of the method may be performed by shared data server 108. As shown in FIG. 4, process 400 may begin when merchant site 104 opts in to sharing data (402) and consumer 110 opts in to sharing data (404). In some embodiments, merchant site 104 may opt in to sharing data with a provider of shared data server 108 and/or remote server 102. Consumer 110 may opt in to sharing data via interacting with remote server 102 or at merchant site 104. In some embodiments, stapes 402 and 404 may be performed in any order.

After consumer 110 has opted into sharing data, shared data server 108 may then receive consumer information from remote server 102 (406). In some embodiments, the received information may include information on consumer 110, such as past purchases and payments processed by remote server 102, including items purchased, and the location of purchases. In some embodiments, the received consumer information may be sent from account database 114 and stored by remote server database 130 of shared data server 108. Shared data server 108 may also receive financial information of consumer 110 (408). In some embodiments, the received financial information may include a credit score of consumer 110 and other information related to the finances of consumer 110. In some embodiments, the received financial information may be received from credit database 116 and stored by remote server database 130 of shared data server 108. In some embodiments, the received consumer financial information may be used by data analysis application 134 to determine a creditworthiness of consumer 110. Moreover, in some embodiments, the received consumer information and consumer financial information may be stored in remote server database 130 such that the information is not accessible by merchant site 104.

After merchant site 104 opts in to sharing data, process 400 may include receiving a catalog and product information from merchant site 104 (410). In some embodiments, product catalog 120 and information for each product and item in catalog 120 may be received by shared data server 108 from merchant site 104 and stored in merchant database 132 such that information stored in merchant database 132 is not accessible by remote server 102. Shared data server 108 may also receive merchant specials and promotions from merchant site 104 (412). In some embodiments, the merchant specials and promotions may be periodically received and or dynamically received as they are generated by merchant site 104. Shared data server 108 may also receive consumer information 118 from merchant site 104 (414). Such information may include past purchases made by consumer 110 and other consumers at merchant site 104 (both physical and digital storefronts), including items purchased, amounts paid, and the locations of such purchases.

After shared data server 108 has received sufficient information, data analysis application 134 may analyze the received information (416). In some embodiments, analyzing the received information may include performing data extraction algorithms, pattern and classification algorithms, and the like so that data analysis application 134 is capable of providing relevant information to remote server 102 and merchant site 104 to enhance an experience of consumer 110 and sufficiently utilize the information. Merchant site 104 may then enhance the experience of consumer 110 by offering credit, offering upgrades and accessories, and specials or promotions (418). In some embodiments, credit may only be offered to consumer 110 if consumer 110 qualifies for credit that is in excess of the price of the items that consumer 110 is attempting to purchase from merchant site. Similarly, the specials, promotions, upgrades and accessories may be provided to consumer 110 based on information stored in merchant database 132 that is related to the items that consumer 110 is purchasing and information related to consumer 110. In some embodiments, the specials, promotions, upgrades and accessories may be provided to consumer 110, may be provided to merchant site 104 to present to consumer 110 in response to receiving a request for information from merchant site 104 triggered by consumer 110 purchasing an item. In some embodiments, remote server 102 may be provided with information by shared data server 108 to enhance the experience of consumer 110. Moreover, once steps 402 and 404 have been performed, steps 406-416 may be performed in any order. Process 400 may allow a remote server 102 and one or more merchant sites 104 to share their respective information and pool their knowledge so that they are able to receive recommendations, offers, and other information for enhancing the experience of a consumer that also provide opportunities for increasing their own profits.

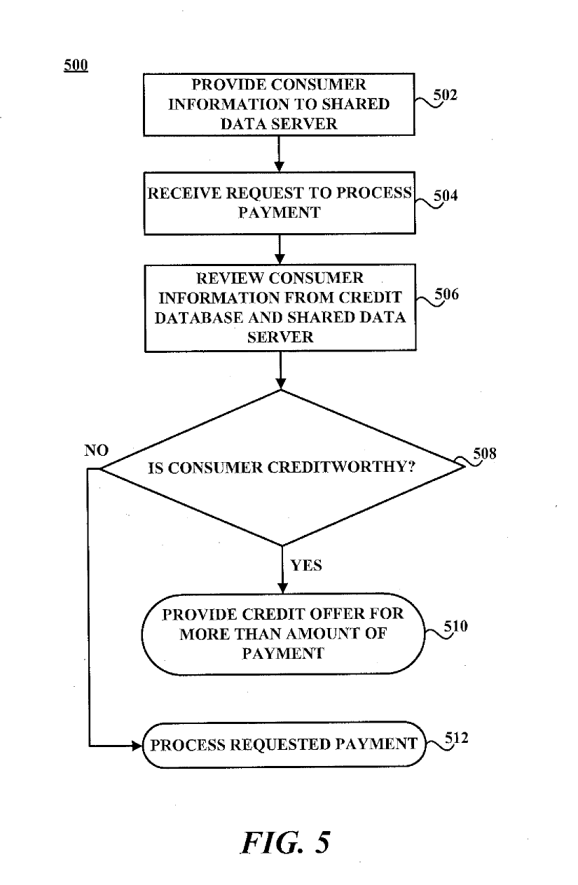

FIG. 5 is a flowchart illustrating a process 500 for offering a consumer credit using shared data, consistent with some embodiments. For the purpose of illustration, FIG. 5 may be described with reference to any of FIGS. 1-3. Process 500 shown in FIG. 5 may be embodied in computer-readable instructions for execution by one or more processors such that the steps of the method may be performed by remote server 102. As shown in FIG. 5, process 500 begins when remote server 102 provides consumer information to shared data server 108 (502). The provided information may include information on consumer 110, such as past purchases and payments processed by remote server 102, including items purchased, and the location of purchases. The provided consumer information may further include a credit score of consumer 110 and other information related to the finances of consumer 110. In some embodiments, the provided consumer information may be sent from account database 114 and credit database and stored by remote server database 130 of shared data server 108. In some embodiments, consumer 110 may be required to opt in to sharing data before the consumer information is provided to shared data server 108.

Remote server 102 may then receive a request to process a payment (504). In some embodiments, the request to process a payment may be a request to process a payment for purchasing an item from merchant site 104. In some embodiments, the request may be received from consumer computing device 112, including from application 128, or from merchant site 104. Remote server 102 may then review consumer information from credit database 116 and information provided by data analysis application 134 of shared data server (506) to determine if consumer is creditworthy (508). In some embodiments, remote server 102 may review information from credit database 116 to determine if consumer has a payment history, a credit score, and other related information to determine if consumer 110 should be provided with an offer for credit. In general, a consumer may be considered to be creditworthy if there is sufficient information to indicate that consumer 110 is capable of and likely to pay back the amount offered for credit. In some embodiments, data analysis application 134 of shared data server 108 may analyze this information stored in remote server database 130 and provide a recommendation to remote server 102 as to whether consumer is creditworthy. Data analysis application 134 of shared data server 108 may also analyze information from merchant database 132 to determine whether consumer is creditworthy. For example, if data analysis application 134 identifies one or more items that consumer would want from merchant site instead of or in addition to the item or items being purchased, data analysis application 134 may determine that there is a good likelihood that consumer would want to purchase these items, and make a credit recommendation accordingly. In some embodiments, the recommendation may be made based on a combination of an analysis of consumer information performed by remote server 102 and data analysis application 134 of shared data server 108.

If consumer 110 is determined to be creditworthy, remote server 102 may provide a credit offer for more than the amount of requested payment to be processed by remote server 102 (510). In some embodiments, data analysis application 134 may recommend an amount for the credit offer based on items in a catalog of merchant site stored in merchant database 132. For example, if consumer 110 is purchasing a product for $X, data analysis application 134 may know that merchant site 104 carries an improved version of the product for $Y, where Y>X, and provide remote server 102 with a recommendation that consumer 110 be provided with an offer of credit for $Y, while simultaneously providing merchant site 104 and/or consumer 110 with a recommendation to purchase the improved product. If consumer 110 is not determined to be creditworthy, remote server 102 may then just process the requested payment (512). As a result, process 500 may allow remote server 102 to provide a reasoned credit offer to consumer 110 when consumer 110 is making a purchase for more than the amount of the purchase to not only provide consumer 110 with more purchasing power, but also provide a larger sale for merchant site 104 while possibly receiving interest and fees from the credit offer.

Software, in accordance with the present disclosure, such as program code and/or data, may be stored on one or more machine-readable mediums, including non-transitory machine-readable medium. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

Consequently, embodiments as described herein may provide systems and methods for sharing data to enhance a consumer experience while also providing opportunities for additional profit. In particular, embodiments as described herein may provide a way for merchants and an online payment processor to pool their information to provide recommendations, specials, targeted advertisements, and credit opportunities that can potentially benefit the merchant, the payment processor, and the consumer. The examples provided above are exemplary only and are not intended to be limiting. One skilled in the art may readily devise other systems consistent with the disclosed embodiments which are intended to be within the scope of this disclosure. As such, the application is limited only by the following claims.

What is claimed is:

1. A shared data system comprising:
a network interface component configured to:
receive consumer information and consumer financial information from a remote server;
receive product information from a merchant server associated with a merchant; and
receive merchant-specific information related to a consumer from the merchant server;
one or more processors configured to:
analyze the received consumer information, consumer financial information, product information and merchant-specific consumer information; and
generate a consumer-related recommendation based on the analysis; and
a memory configured to store the received consumer information and consumer financial information and the product information and merchant-specific consumer information such that the merchant server cannot access information received from the remote server and the remote server cannot access the information received from the merchant server.

2. The system of claim 1, wherein the network interface component is configured to receive product information from the merchant server comprising a catalog of products available from the merchant and descriptions of the available products.

3. The system of claim 1, wherein the network interface component is further configured to receive specials and promotions from the merchant server.

4. The system of claim 3, wherein the one or more processors are further configured to generate a consumer-related recommendation comprising at least one of a credit offer, an upgrade, related products, and a special offer.

5. The system of claim 1, wherein the one or more processors are configured to generate the consumer-related recommendation based on a request to purchase a product from the merchant by the consumer.

6. The system of claim 5, wherein the network interface component is further configured to receive a request for information from the merchant server in response to the request to purchase a product from the merchant by the consumer.

7. The system of claim 5, wherein the network interface component is further configured to receive a request for information from the remote server in response to the request to purchase a product from the merchant by the consumer.

8. The system of claim 1, wherein the remote server comprises a payment processing server.

9. The system of claim 1, wherein the memory comprises a first database configured to store the received consumer information and consumer financial information and a second database configured to store the product information and merchant-specific consumer information.

10. A method for enhancing an experience of a consumer using shared data, comprising:
receiving, by a shared data server, consumer information and consumer financial information from a remote server;
receiving, by the shared data server, product information from a merchant server associated with a merchant; and
receiving, by the shared data server, merchant-specific information related to a consumer from the merchant server;
storing, by one or more databases of the shared data server, the received consumer information and consumer financial information and the product information and merchant-specific consumer information such that the merchant server cannot access information received from the remote server and the remote server cannot access the information received from the merchant server
analyzing, by one or more processors of the shared data server, the received consumer information, consumer financial information, product information and merchant-specific consumer information; and
generating, by the one or more processors of the shared data server, a consumer-related recommendation based on the analysis.

11. The method of claim 10, wherein receiving product information from the merchant server comprises receiving a catalog of products available from the merchant and descriptions of the available products.

12. The method of claim 10, further comprising receiving, by the shared data server, specials and promotions from the merchant server.

13. The method of claim 12, wherein generating the consumer-related recommendation comprises generating, by the one or more processors of the shared data server, at least one of a credit offer, an upgrade, related products, and a special offer.

14. The method of claim 10, wherein generating the consumer-related recommendation comprises:
receiving, by the shared data server, a request for information; and
generating, by the one or more processors of the shared data server, the consumer-related recommendation in response to the received request.

15. The method of claim 14, wherein receiving a request for information comprises receiving the request for information from at least one of the remote server and the merchant server.

16. The method of claim 10, wherein the remote server comprises a payment processing server.

17. A computer-readable medium including instructions that when executed by one or more processors of a payment processing server cause the one or more processors to perform a method comprising:
receiving a request to process a payment from a consumer to a merchant;
reviewing information from a credit database;
reviewing information received from a shared data server in communication with the payment processing server;
determining if the consumer requesting the payment to be processed should be extended an offer for credit based on the received information;
providing a credit offer for an amount greater than an amount of the payment that the consumer requested to be processed when the determining determines that the consumer should be extended an offer for credit; and
processing the requested payment when the determining determines that the consumer should not be extended an offer for credit.

18. The computer-readable medium of claim 17, wherein reviewing information from a credit database comprises reviewing information including a credit score of the consumer and past payments processed by the payment processing server for the consumer.

19. The computer-readable medium of claim 17, wherein reviewing information from a shared data server comprises reviewing information including a credit score of the consumer, past purchases made by the consumer from the merchant, additional products offered by the merchant, and specials and promotions currently offered by the merchant.

20. The computer-readable medium of claim 19, wherein determining if the consumer should be extended an offer for credit comprises determining if products offered by the merchant have a greater quality than products for which the consumer is currently requesting a payment to be processed.

21. The computer-readable medium of claim 19, wherein determining if the consumer should be extended an offer for credit comprises determining if products offered by the merchant are suitable accessories for the products for which the consumer is currently requesting a payment to be processed.
